(19) United States
(12) Patent Application Publication
(10) Pub. No.: US 2016/0288345 A1
(43) Pub. Date: Oct. 6, 2016

(54) Compact Cutter with Ceramic Blade

(71) Applicant: Acme United Corporation, Fairfield, CT (US)

(72) Inventors: Christopher J. Alagno, Oxford, CT (US); Nicholas L. Seferi, Southbury, CT (US)

(21) Appl. No.: 15/088,325

(22) Filed: Apr. 1, 2016

Related U.S. Application Data
(60) Provisional application No. 62/141,528, filed on Apr. 1, 2015.

(51) Int. Cl. B26B 5/00; B26B 9/00

(52) U.S. Cl. CPC B26B 5/003; B26B 9/00; B26B 5/005

(57) ABSTRACT

A compact cutter employs a ceramic blade. The ceramic blade may be fixed or retractable and configured to easily cut paper or other thin material without readily cutting or injuring the user. A paper cutter employs a blade that can be easily replaced without the need for auxiliary tools.

### BACKGROUND

The present disclosure relates generally to utility knives or paper cutters, and more particularly, to portable compact utility cutters.

Conventional paper cutters are found in numerous forms and dimensions. Many paper cutters are unwieldy and have cutting surfaces dangerous to the end user. It is common for paper cutters or utility knives to use metallic blades designed to have a compact form and which need to be replaced often. These metallic blades can easily cut the skin of the user and are otherwise prone to cause injury. Such blades also wear out or corrode, thereby limiting the usable life of the paper cutter. It would be advantageous to provide a paper cutter that incorporates an alternative blade that is more effective, safer, longer lasting, and easier to replace.

A compact ceramic cutter comprises a blade fixed within a holder. The holder has a longitudinal guide surface. The blade is made of a ceramic material and protrudes from the longitudinal guide surface. The holder separates into two lateral sections without the need for tools to allow the user to replace the blade.

### SUMMARY

Briefly stated, one embodiment of the present invention is directed to a paper cutter that uses a fixed or retractable ceramic blade that easily cuts paper or other thin material but does not readily cut or injure the user. One embodiment is also directed to a paper cutter that employs a blade that can be easily replaced without the need for auxiliary tools.

The holder may further comprise a loop dimensioned to easily and comfortably accommodate the user's finger. In one embodiment, the holder also comprises a button and a slide. The blade protrudes in an extended position from the longitudinal guide surface only when the button is depressed by the user. The blade moves along the slide to the extended position and is biased to automatically return to a retracted position when said button is not depressed by the user. The holder further has a key-ring hole to affix the compact ceramic cutter to a key-ring or a lanyard. The holder further comprises a magnet to affix the compact ceramic cutter to a metallic or magnetic surface.

### BRIEF DESCRIPTION OF THE DRAWINGS

FIG. 1 is a side view of a one embodiment of a compact ceramic cutter according to aspects of the disclosure;

FIG. 2A is a side view of an alternate embodiment of a compact ceramic cutter according to aspects of the disclosure;

FIG. 2B is a side view of the compact ceramic cutter of FIG. 2A in a retracted state;

FIG. 2C is an opposite side view of the compact ceramic cutter of FIG. 2B;

FIG. 3A is a side view of an alternate embodiment of a compact ceramic cutter according to aspects of the disclosure;

FIG. 3B is a side view of the compact ceramic cutter of FIG. 3A in a retracted state;

FIG. 3C is a top view of the compact ceramic cutter of FIG. 3B;

FIG. 3D is an opposite side view of the compact ceramic cutter of FIG. 3B; and

FIG. 4 is a side plan view of a ceramic blade according to aspects of the disclosure.

### DETAILED DESCRIPTION

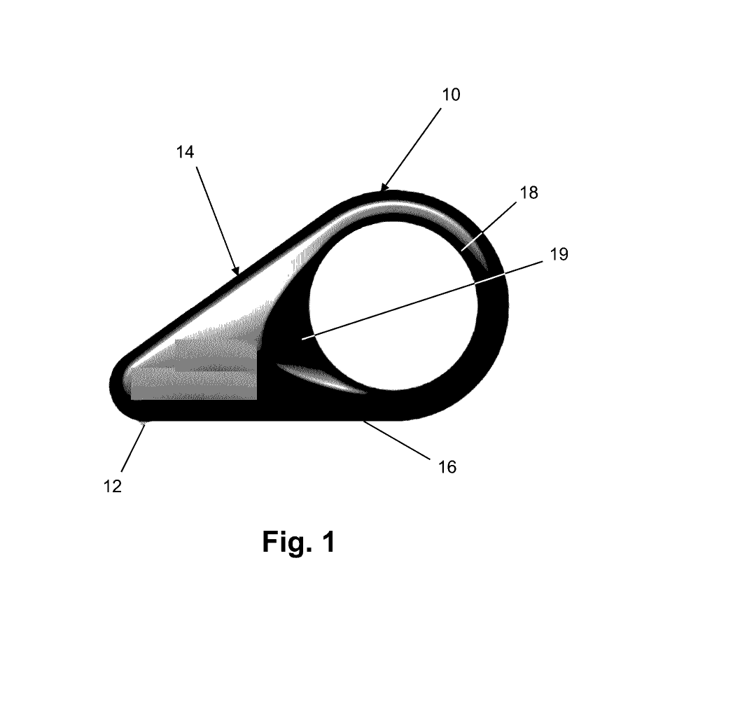

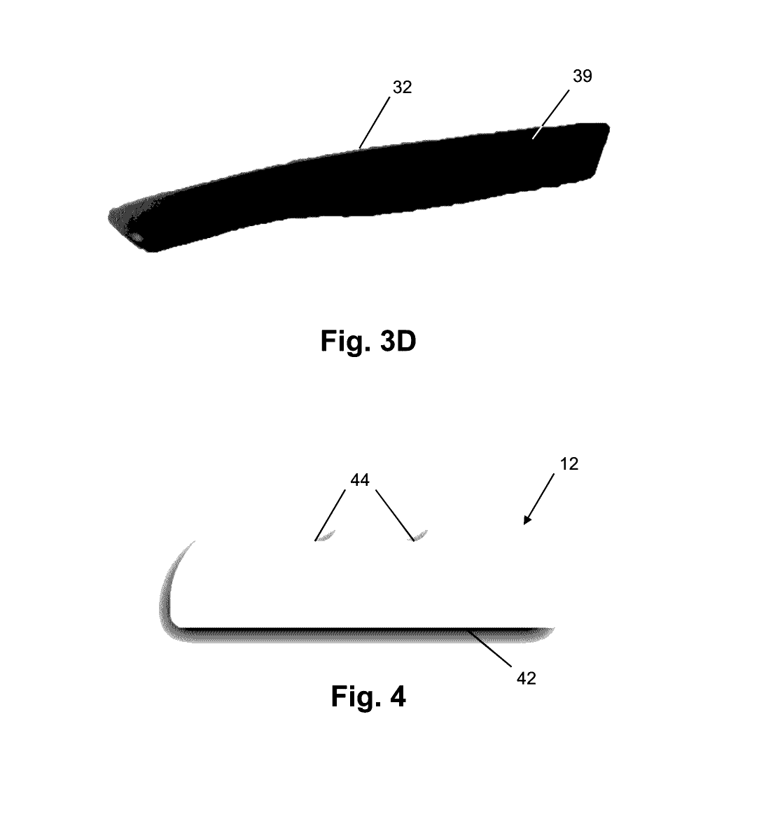

Referring to FIG. 1, wherein like numerals indicate like elements, there is shown a representative embodiment of a compact ceramic cutter 10. Ceramic cutter 10 contains a blade 12 fixed within a holder 14. In the depicted embodiment, the blade 12 is embedded in the holder 14 and protrudes a desired amount from a longitudinal guide surface 16. The holder 14 contains a loop 18 dimensioned to easily and comfortably accommodate a user's finger. The holder 14 separates into two lateral sections without the need for tools to allow the end user to replace the blade 12. The blade 12 is depicted in greater detail in FIG. 4.

In one embodiment, the blade 12 cuts through paper or other thin materials without posing serious danger to the user's skin. The blade 12 is oriented such that the end user pulls the loop 18 with his or her finger along the desired cutting material. Blade 12 follows the longitudinal guide surface 16 as the blade 12 cuts through the paper or other thin material. Longitudinal guide surface 16 is arranged as a cutting guide such that the blade 12 penetrates a consistent depth as the user pulls loop 18 along the material. The blade 12 is oriented and configured such that the cutting surface cuts the material with minimal required force by the end user. The loop 18 is arranged such that the user can easily pull the cutter 10 along the material and push the cutter 10 against the material.

In the embodiment depicted in FIG. 1, a recess 19 defined in the surface of the holder 14 adjacent the loop 18 provides a comfortable and natural gripping surface for the user's other fingers to provide favorable ergonomic qualities of the ceramic cutter 10. The recess 19 is configured to ease and facilitate cutting operations, particularly when the user desires curved or other complex cutting patterns.

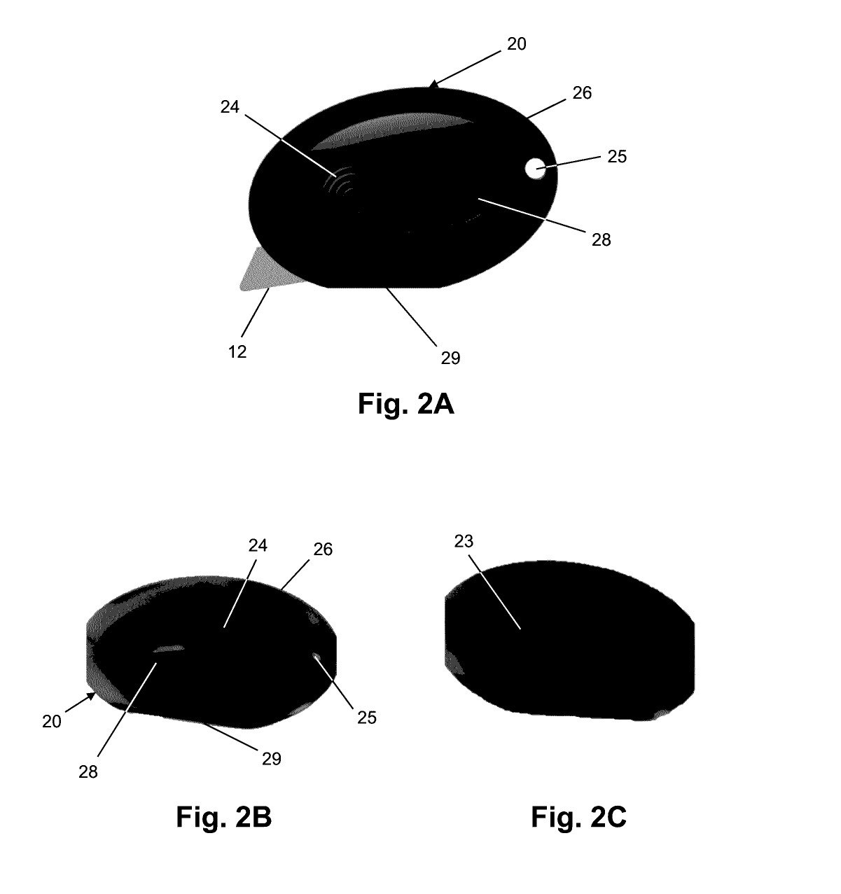

In the embodiment depicted in FIGS. 2A-2C, ceramic cutter 20 contains a blade 12 which reciprocates within a casing 26. A button 24 moves the blade 12 along a slide 28 between an extended position as depicted in FIG. 2A and a retracted position as depicted in FIG. 2B. The button 24 locks the blade 12 in the retracted position and allows movement of blade 12 to the extended position only when the button 24 is depressed. The blade 12 is biased to automatically return to the retracted position when the user is not depressing the button 24 and holding the blade 12 in the extended position.

Referring to FIG. 2A, the casing 26 contains a longitudinal guide 29 that assists the user during operation to maintain the blade 12 at a constant depth while cutting. In the depicted embodiment, the casing 26 also contains a key-ring hole 25. Key-ring hole 25 allows the end user to affix the ceramic cutter 20 to a key-ring, lanyard, or the like. Referring to FIG. 2C, the casing 26 contains a magnet 23 to affix the casing 26 to outside metallic or magnetic surfaces. Other embodiments include similar key-ring holes and magnets.

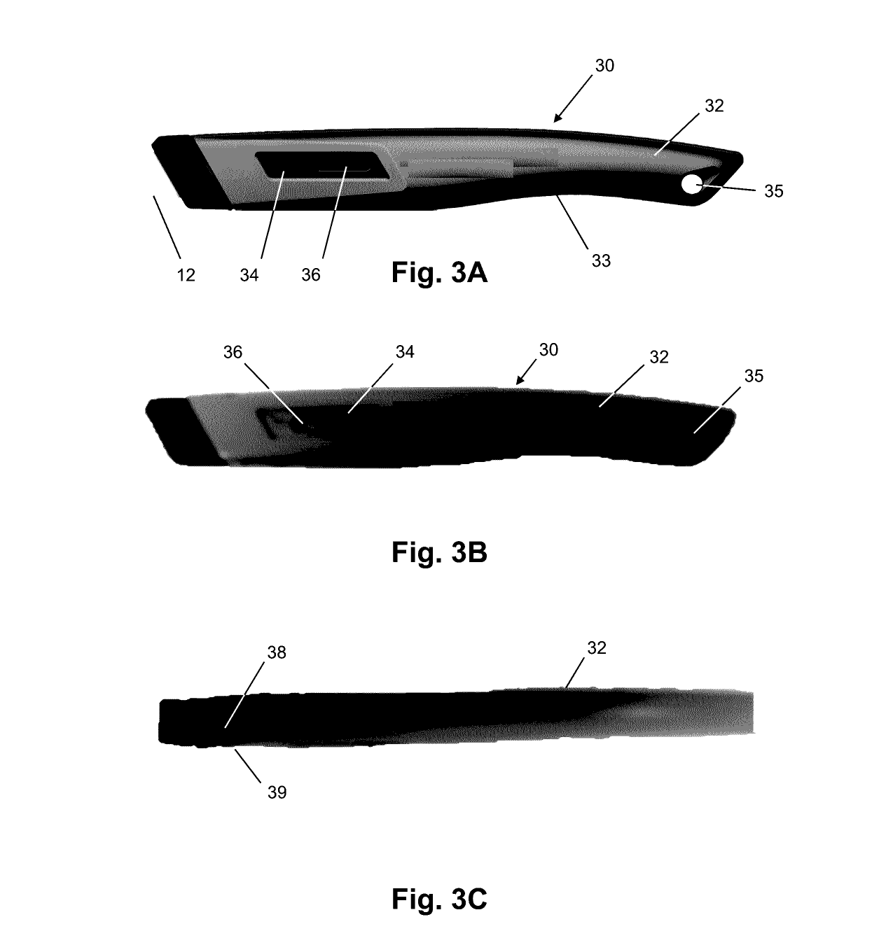

Referring to FIGS. 3A-3D, a ceramic blade box cutter 30 contains a handle 32 and a button 34. The user depresses the button 34 and moves the button 34 along a track 36 to expose a blade 12 from the handle 32 to an extended position as depicted in FIG. 3A. When the user stops exerting a force on the button 34, the blade 12 returns to the retracted state and is protected within the handle 12 as depicted in FIG. 3B. In the depicted embodiment, the handle 32 also contains a key-ring hole 35. Key-ring hole 35 allows the end user to affix the box cutter 30 to a key-ring, lanyard, or the like. Box cutter 30 also contains a grip 33 to provide an ergonomic surface for the user's hand. In one embodiment, the handle 32 is approximately 5.25 to 6.25 inches long and 0.25 to 1 inches tall.

Referring to FIG. 3C, a tab 38 allows the user to replace the blade 12 without needing auxiliary tools. When the tab 38 is depressed, a collar 39 (depicted in FIGS. 3B and 3C) separates from the handle 32 and the entire blade 12 is exposed. The user may adjust the blade 12 within the handle 32 or replace it with a new blade 12. In one embodiment, when the collar 39 is separated from the handle 32 a blade storage bay (not depicted) is also exposed. The blade storage bay allows storage of spare blades 12 not currently in use.

Referring to FIG. 4, a blade 12 has a cutting edge 42 and opposed mounting recesses 44. The depicted blade 12 is compatible with all embodiments of the present disclosure. In the depicted embodiment, opposite longitudinal ends of the cutting edge 42 are curved for added safety. The mounting recesses 44 mate with complementary tabs (not depicted) within each ceramic cutter. The depicted blade 12 is symmetrical with dual functional cutting edge portions, allowing the user to reverse the blade to expose and sequentially use both ends of cutting edge 42. This further increases the life of a single blade 12. In one embodiment, the blade 12 is approximately 25 millimeters long and 6.55 millimeters tall.

While preferred embodiments of the foregoing have been set forth for purposes of illustration, the foregoing description should not be deemed a limitation of the inventions herein. Accordingly, various modifications, adaptations and alternatives may occur to one skilled in the art without departing from the spirit and the scope of the present invention.

1. A compact ceramic cutter comprising:
a blade fixed within a holder, said holder having a longitudinal guide surface, said blade being made of a ceramic material and protruding from said longitudinal guide surface;
wherein said holder separates into two lateral sections without the need for tools to allow a user to replace said blade.

2. The compact ceramic cutter of claim 1, wherein said holder further comprises a loop dimensioned to easily and comfortably accommodate the user's finger.

3. The compact ceramic cutter of claim 1, wherein said holder further comprises a button and a slide;
wherein said blade protrudes in an extended position from said longitudinal guide surface only when said button is depressed by the user, said blade moves along said slide to said extended position and is biased to automatically return to a retracted position when said button is not depressed by the user.

4. The compact ceramic cutter of claim 1, wherein said holder further defines a key-ring hole to affix said compact ceramic cutter to a key-ring or lanyard.

5. The compact ceramic cutter of claim 1, wherein said holder further comprises a magnet to affix said compact ceramic cutter to metallic or magnetic surfaces.
